(19) United States
(12) Patent Application Publication
(10) Pub. No.: US 2017/0305530 A1
(43) Pub. Date: Oct. 26, 2017

(54) SYSTEM AND METHOD FOR CONTROLLING AIRCRAFT WING FLAP MOTION

(71) Applicant: THE BOEING COMPANY, Chicago, IL (US)

(72) Inventors: Michael Raymond Finn, Kirkland, WA (US); Patrick McCormick, Mukilteo, WA (US); George Moy, Seattle, WA (US); Rene Toan Nguyen, Edmonds, WA (US)

(73) Assignee: THE BOEING COMPANY, Chicago, IL (US)

(21) Appl. No.: 15/137,826

(22) Filed: Apr. 25, 2016

(51) Int. Cl. B64C 13/02; B64C 9/16; B64C 9/14

(52) U.S. Cl. CPC B64C 13/02; B64C 9/14; B64C 9/16

(57) ABSTRACT

A system and method of controlling one or more flaps of an aircraft may include receiving first and second sensor signals from respective first and second sensors coupled to respective first and second actuators that are moveably secured to a first flap of a first wing of the aircraft. The first and second sensor signals relate to one or both of the position or the speed of the respective first and second actuators. The system and method may also include comparing the first and second sensor signals to determine a difference between the first and second sensor signals, and adjusting the speed of one or both of the first or second actuators based on the difference between the first and second sensor signals. A system and method may include determining a difference between one or both of speed or position of the first and second flaps, and adjusting the speed of one or both of the first and second flaps based on the difference between one or both of the speed or the position of the first and second flaps.

### FIELD OF THE DISCLOSURE

Embodiments of the present disclosure generally relate to a system and method for controlling flap motion of wings of an aircraft.

### BACKGROUND OF THE DISCLOSURE

High-lift systems are utilized on wings of aircraft to increase lift or drag during take-offs and landings. One type of high-lift system includes flaps on trailing edges of the wings. The flaps are moveable control surfaces that may be extended during take-offs and landings, and retracted at cruising speeds.

A variety of actuation systems may be used to extend and retract trailing-edge flaps on a wing. One known type of actuation system includes two drive stations, with each drive station connected to an opposite side of the flap. A distributed actuation system includes a drive station installed on either side of a flap with no mechanical interaction between the drive stations. A known drive station includes a motor, a gear train, and a drive screw that connects to the flap through an arm. The motor (for example, an electric motor) in a drive station turns the drive screw in a forward or reverse direction through the gear train. The drive screw converts the rotation motion of the motor and gear train into a linear motion to impart movement on the arm. As the arm is pushed or pulled by the drive screw, the flap connected to the arm is extended or retracted.

Because a flap is typically actuated by two drive stations, if one drive station moves at a different rate than the other drive station, the flap may skew or twist under sufficient airloads. For example, when the flap is actively extended or retracted by the two drive stations that are moving at different rates, the flap may be susceptible to skewing or twisting.

### SUMMARY OF THE DISCLOSURE

A need exists for a system and method that synchronizes flap motion of one or more wings of an aircraft. A need exists for a system and method that prevents, minimizes, or otherwise reduces the potential of a flap to skew or twist during operation. Further, a need exists for a system and method that prevent, minimize, or otherwise reduce asymmetry between wings of an aircraft flap system, as wing asymmetry may cause an aerodynamic rolling moment.

With those needs in mind, certain embodiments of the present disclosure provide a system for controlling one or more flaps of an aircraft. The system may include a first flap moveably secured to a first wing of the aircraft. The first flap is moveable between an extended position and a retracted position. A first actuator is coupled to the first flap. A first sensor is coupled to the first actuator. The first sensor is configured to determine one or both of a position or speed of the first actuator. The first sensor is further configured to output a first sensor signal that relates to one or both of the position or the speed of the first actuator. A second actuator is also coupled to the first flap. A second sensor is coupled to the second actuator. The second sensor is configured to determine one or both of a position or speed of the second actuator. The second sensor is further configured to output a second sensor signal that relates to one or both of the position or the speed of the second actuator. A control unit is in communication with the first actuator, the first sensor, the second actuator, and the second sensor. The control unit is configured to receive the first and second sensor signals from the first and second sensors, respectively, compare the first and second sensor signals to determine a difference between the first and second sensor signals, and adjust the speed of one or both of the first or second actuators based on the difference between the first and second sensor signals.

The control unit may be configured to adjust the speed of one or both of the first and second actuators by decreasing the speed of a leading one of the first and second actuators that leads a lagging one of the first and second actuators until the lagging one of the first and second actuators catches up to the leading one of the first and second actuators. In at least one other embodiment, the control unit may be configured to adjust the speed of one or both of the first and second actuators by increasing the speed of a lagging one of the first and second actuators that lags behind a leading one of the first and second actuators until the lagging one of the first and second actuators catches up to the leading one of the first and second actuators. In at least one other embodiment, the control unit is configured to adjust the speed of one or both of the first and second actuators by decreasing the speed of a leading one of the first and second actuators that leads a lagging one of the first and second actuators and increasing the speed of the lagging one of the first and second actuators until the lagging one of the first and second actuators catches up to the leading one of the first and second actuators.

The system may also include a second flap moveably secured to a second wing of the aircraft. The second flap is moveable between an extended position and a retracted position. A third actuator is coupled to the second flap. A third sensor is coupled to the third actuator. The third sensor is configured to determine one or both of a position or speed of the third actuator and output a third sensor signal related to one or both of the position or the speed of the third actuator. A fourth actuator is coupled to the second flap. A fourth sensor is coupled to the fourth actuator. The fourth sensor is configured to determine one or both of a position or speed of the fourth actuator and output a fourth sensor signal related to one or both of the position or the speed of the fourth actuator. The control unit is in communication with the third actuator, the third sensor, the fourth actuator, and the fourth sensor. The control unit is further configured to receive the third and fourth sensor signals from the third and fourth sensors, respectively, compare the third and fourth sensor signals to determine a difference between the third and fourth sensor signals, and adjust the speed of one or both of the third or fourth actuators based on the difference between the third and fourth sensor signals.

The control unit may be configured to determine a difference between one or both of speed or position of the first and second flaps, and adjust the speed of one or both of the first and second flaps based on the difference between one or both of the speed or the position of the first and second flaps. The control unit may be configured determine the difference between one or both of the speed or position of the first and second flaps by analyzing the first, second, third, and fourth sensor signals.

The control unit may be configured to adjust the speed of one or both of the first and second flaps by decreasing the speed of a leading one of the first and second flaps that leads a lagging one of the first and second flaps until the lagging one of the first and second flaps catches up to the leading one of the first and second flaps. In at least one other embodiment, the control unit is configured to adjust the speed of one or both of the first and second flaps by increasing the speed of a lagging one of the first and second flaps that lags behind a leading one of the first and second flaps until the lagging one of the first and second flaps catches up to the leading one of the first and second flaps. In at least one other embodiment, the control unit is configured to adjust the speed of one or both of the first and second flaps by decreasing the speed of a leading one of the first and second flaps that leads a lagging one of the first and second flaps and increasing the speed of the lagging one of the first and second flaps until the lagging one of the first and second flaps catches up to the leading one of the first and second flaps.

Certain embodiments of the present disclosure provide a method of controlling one or more flaps of an aircraft. The method may include receiving first and second sensor signals from respective first and second sensors coupled to respective first and second actuators that are moveably secured to a first flap of a first wing of the aircraft. The first and second sensor signals relate to one or both of the position or the speed of the respective first and second actuators. The method may also include comparing the first and second sensor signals to determine a difference between the first and second sensor signals, and adjusting the speed of one or both of the first or second actuators based on the difference between the first and second sensor signals.

Certain embodiments of the present disclosure provide a system for controlling one or more flaps of an aircraft. The system includes a first flap moveably secured to a first wing of the aircraft. The first flap is moveable between an extended position and a retracted position. A second flap is moveably secured to a second wing of the aircraft. The second flap is moveable between an extended position and a retracted position. A control unit is configured to determine a difference between one or both of speed or position of the first and second flaps, and adjust the speed of one or both of the first and second flaps based on the difference between one or both of the speed or the position of the first and second flaps.

In at least one embodiment, the control unit is configured to determine the difference between one or both of the speed or position of the first and second flaps by analyzing a plurality of sensor signals output by sensors of actuators that are coupled to the first and second flaps.

The control unit may be configured to adjust the speed of one or both of the first and second flaps by decreasing the speed of a leading one of the first and second flaps that leads a lagging one of the first and second flaps until the lagging one of the first and second flaps catches up to the leading one of the first and second flaps. The control unit may be configured to adjust the speed of one or both of the first and second flaps by increasing the speed of a lagging one of the first and second flaps that lags behind a leading one of the first and second flaps until the lagging one of the first and second flaps catches up to the leading one of the first and second flaps. The control unit may be configured to adjust the speed of one or both of the first and second flaps by decreasing the speed of a leading one of the first and second flaps that leads a lagging one of the first and second flaps and increasing the speed of the lagging one of the first and second flaps until the lagging one of the first and second flaps catches up to the leading one of the first and second flaps.

Certain embodiments of the present disclosure provide a method of controlling one or more flaps of an aircraft. The method may include determining a difference between one or both of speed or position of first and second flaps of respective first and second wings of the aircraft. The first and second flaps are moveable between an extended position and a retracted position. The method may also include adjusting the speed of one or both of the first and second flaps based on the difference between one or both of the speed or the position of the first and second flaps.

In at least one embodiment, the determining a difference operation includes analyzing a plurality of sensor signals output by sensors of actuators that are coupled to the first and second flaps.

The adjusting the speed operation may include decreasing the speed of a leading one of the first and second flaps that leads a lagging one of the first and second flaps until the lagging one of the first and second flaps catches up to the leading one of the first and second flaps. The adjusting the speed operation may include increasing the speed of a lagging one of the first and second flaps that lags behind a leading one of the first and second flaps until the lagging one of the first and second flaps catches up to the leading one of the first and second flaps. The adjusting the speed operation may include decreasing the speed of a leading one of the first and second flaps that leads a lagging one of the first and second flaps, and increasing the speed of the lagging one of the first and second flaps until the lagging one of the first and second flaps catches up to the leading one of the first and second flaps.

### BRIEF DESCRIPTION OF THE DRAWINGS

FIG. 1 is a diagrammatic representation of a schematic view of a flap synchronization system, according to an embodiment of the present disclosure.

FIG. 2 illustrates a flow chart of a method of synchronizing actuators coupled to a flap of wing of an aircraft, according to an embodiment of the present disclosure.

FIG. 3 illustrates a flow chart of a method of synchronizing flaps moveably secured to wings of an aircraft, according to an embodiment of the present disclosure.

FIG. 4 is a diagrammatic representation of a top plan view of an aircraft, according to an embodiment of the present disclosure.

FIG. 5 is a diagrammatic representation of an actuator, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Embodiments of the present disclosure are applicable to high lift actuation systems that use distributed flap actuation. Embodiments of the present disclosure provide systems and methods that reduce flap skew by sensing a position and/or speed of the actuators coupled to a flap, and, in response, adjust the speed of one or more of the actuators, so as to synchronize the actuators. The position and/or speed of actuators associated with one or more other flaps are sensed, and adjusted accordingly, so as to improve aerodynamic characteristics (or, stated differently, reduce negative aerodynamic effects).

Certain embodiments of the present disclosure provide an aircraft (such a commercial aircraft, military aircraft, drone, and/or the like) that may include a wing having a flap, a plurality of actuators that are coupled to the flap and configured to position the flap, a first sensor associated with a first actuator for determining one or both of speed or position of the first actuator, a second sensor associated with a second actuator for determining one or both speed or position of the second actuator, and a control unit or controller that is configured to determine a difference between the speed and/or position of the first actuator and the speed and/or position of the second actuator. The control unit identifies which of the actuators is a leading actuator and which of the actuators is a lagging actuator, and adjusts the speed of the leading actuator (such as by reducing its speed) so that the difference in position between the leading actuator and lagging actuator is reduced, thereby reducing the amount and/or likelihood of flap skew.

Certain embodiments of the present disclosure provide a method of controlling first and second actuators that are used to position a flap of a wing of an aircraft. The method may include determining one or both of a position or speed of the first actuator, determining one or both of a position or speed of the second actuator, comparing the position and/or speed of the first actuator to the position and/or speed of the second actuator, determining which of the first and second actuators is slower, determining whether the position of first actuator is furthest from a desired position or whether the position of the second actuator is furthest from the desired position, so as to identify one of the first and a second actuators as a leading actuator and one of the first and second actuators as a lagging actuator, adjusting the speed of the leading actuator, thereby allowing the lagging actuator to catch-up to the leading actuator.

Additionally, embodiments of the present disclosure provide systems and methods that are configured to synchronize motion between different flaps of an aircraft. For example, a control unit may monitor the speed and/or position of first and second flaps, and synchronize motion of the first and second flaps.

An actuator is leading if it is at a relative position and/or speed ahead of and/or greater than (in relation to a desired direction of travel) a relative position or speed of another actuator, which may be coupled to the same or a different flap. Conversely, an actuator is lagging if it is at a relative position and/or speed behind or less than (in relation to a desired direction of travel) a relative position or speed of another actuator, which may be coupled to the same or a different flap.

Similarly, a flap is leading if it is at a relative position and/or speed ahead of and/or greater than (in relation to a desired direction of travel) a relative position or speed of another flap. Conversely, a flap is lagging if it is at a relative position and/or speed behind or less than (in relation to a desired direction of travel) a relative position or speed of another flap.

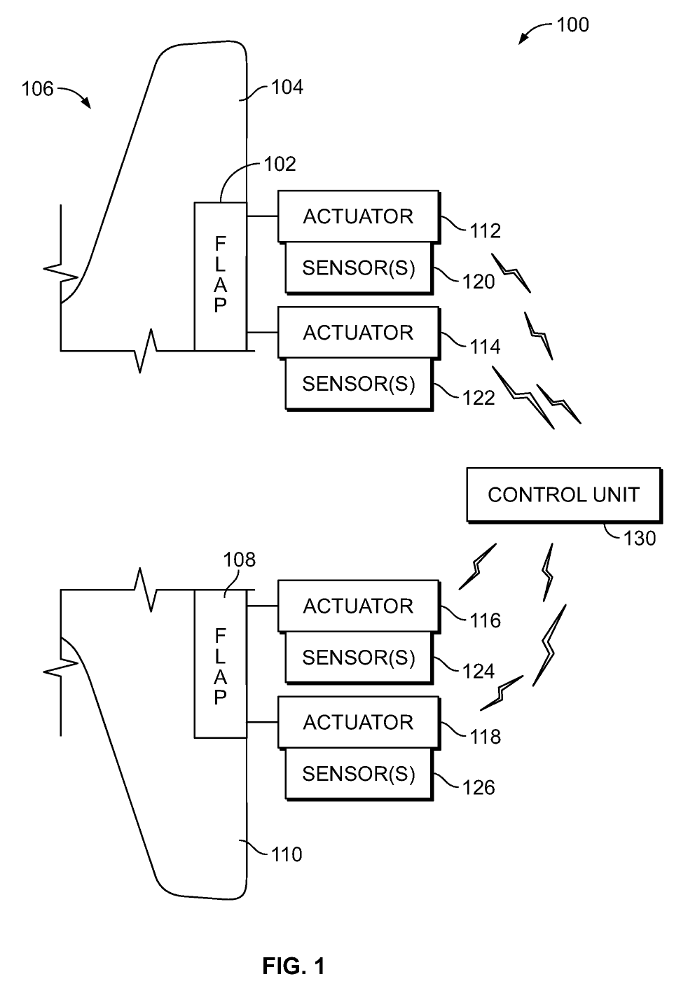

FIG. 1 is a diagrammatic representation of a schematic view of a flap synchronization system 100, according to an embodiment of the present disclosure. The flap synchronization system 100 includes a flap 102 on a wing 104 of an aircraft 106 and a flap 108 on an opposite wing 110 of the aircraft 106. The flaps 102 and 108 may be trailing edge flaps on the wings 104 and 110, respectively.

The flap 102 is coupled to actuators 112 and 114, while the flap 108 is coupled to actuators 116 and 118. The actuators 112 and 118 may be outboard actuators, while the actuators 114 and 116 may be inboard actuators. The actuators 112, 114, 116, and 118 may be electromechanical actuators that are configured to actuate the flaps 102 and 108 between retracted and extended positions. The actuators 112, 114, 116, and 118 may be drive stations, such as shown and described in U.S. Pat. No. 9,193,479, entitled “Monitoring of High-Lift Systems for Aircraft,” which is hereby incorporated by reference in its entirety. Optionally, the actuators 112, 114, 116, and 118 may be various other types of devices that are used to move the flaps 102 and 108. For example, the actuators 112, 114, 116, and 118 may be or include powered pivotal harnesses, linkages, and/or the like. The actuators 112, 114, 116, and 118 may be secured within the wings 104 and 110. Optionally, the actuators 112, 114, 116, and 118 may be located within a fuselage of the aircraft 106, and coupled to the flaps 102 and 108 through links, coupling, and/or the like.

As shown, the actuators 112 and 114 may be installed on opposite sides or ends of the flap 102, while the actuators 116 and 118 may be installed on opposite sides or ends of the flap 108. Optionally, the actuators 112 and 114 may be installed at other areas of the flap, while the actuators 116 and 118 may be installed at different areas of the flaps 108. There may be no mechanical interaction between the actuators 112 and 114, and no mechanical interaction between the actuators 116 and 118. As such, the aircraft 106 may provide a distributed high-lift system.

While the flap 102 is shown coupled to the two actuators 112 and 114 and the flap 108 is shown coupled to the two actuators 116 and 118, each of the flaps 102 and 108 may be coupled to additional actuators. For example, each of the flaps 102 may be coupled to three or more actuators.

One or more sensors 120 are coupled to the actuator 112 and/or the flap 102. The sensor(s) 120 may be configured to sense a rate or speed of the actuator 112 and/or the flap 102. The sensor(s) 120 may also (or alternatively) be configured to sense a position of the actuator 112 and/or the flap 102. The sensor(s) 120 may be secured within the wing 104. Optionally, the sensor(s) 120 may be located within a fuselage of the aircraft 106, and coupled to the actuator 112 and/or the flap 102 through links, coupling, and/or the like.

One or more sensors 122 are coupled to the actuator 114 and/or the flap 102. The sensor(s) 122 may be configured to sense a rate or speed of the actuator 114 and/or the flap 102. The sensor(s) 122 may also (or alternatively) be configured to sense a position of the actuator 114 and/or the flap 102. The sensor(s) 122 may be secured within the wing 104. Optionally, the sensor(s) 122 may be located within a fuselage of the aircraft 106, and coupled to the actuator 114 and/or the flap 102 through links, coupling, and/or the like.

One or more sensors 124 are coupled to the actuator 116 and/or the flap 108. The sensor(s) 124 may be configured to sense a rate or speed of the actuator 116 and/or the flap 108. The sensor(s) 124 may also (or alternatively) be configured to sense a position of the actuator 116 and/or the flap 108. The sensor(s) 124 may be secured within the wing 110. Optionally, the sensor(s) 124 may be located within a fuselage of the aircraft 106, and coupled to the actuator 116 and/or the flap 108 through links, coupling, and/or the like.

One or more sensors 126 are coupled to the actuator 118 and/or the flap 108. The sensor(s) 126 may be configured to sense a rate or speed of the actuator 118 and/or the flap 108. The sensor(s) 126 may also (or alternatively) be configured to sense a position of the actuator 118 and/or the flap 108. The sensor(s) 126 may be secured within the wing 110. Optionally, the sensor(s) 126 may be located within a fuselage of the aircraft 106, and coupled to the actuator 118 and/or the flap 108 through links, coupling, and/or the like.

A control unit 130 is operatively coupled to and in communication with the actuators 112, 114, 116, and 118. The control unit 130 may be located within a fuselage of the aircraft 106 (such as within a cockpit), and may be coupled to each actuator 112, 114, 116, and 118 through one or more wired or wireless connections. The control unit 130 is configured to control operation of the actuators 112, 114, and 116, and 118 to control movement of the flaps 102 and 108 based on input from an operator, such as a pilot of the aircraft 106.

The control unit 130 is also coupled to and in communication with the sensors 120, 122, 124 and 126, such as through one or more wired or wireless connections. The control unit 130 receives signals from the sensors 120, 122, 124, and 126 to determine the speed and/or position of each actuator 112, 114, 116, and 118. Based on the signals received from the sensors 120, 122, 124, and 126, the control unit 130 may adjust the motion of the actuators 112, 114, 116, and 118. For example, the control unit 130 may adjust the speed of the actuators 112 and 114 based on the signals received from the sensors 120 and 122 to ensure that the actuators 112 and 114 are synchronized and moving the flap 102 at the same rate. Similarly, the control unit 130 may adjust the speed of the actuators 116 and 118 based on the signals received from the sensors 124 and 126 to ensure that the actuators 116 and 118 are synchronized and moving the flap 108 at the same rate. Additionally, the control unit 130 may sense the speed and/or position of each flap 102 and 108 based on the signals received from the sensors 120, 122, 124, and 126 and adjust the motion of the flaps 102 and 108 to ensure that both the flaps 102 and 108 are synchronized, at a desired position, and moving at a desired rate.

The control unit 130 receives signals from the sensors 120 and 122. The received signals may relate to the speed of the actuators 112, 114, the position of the actuators 112, 114, the speed of the flap 102, and/or the position of the flap 102. For example, the signals output by the sensors 120 and 122 and received by the control unit 130 provide position and speed data of the actuators 112 and 114, respectively.

The control unit 130 compares the signals received from the sensors 120 and 122. The control unit 130 determines whether there is a positional and/or speed difference between the actuators 112 and 114 based on the signals received from the sensors 120 and 122. If there is no difference, the control unit 130 continues to operate the actuators 112 and 114 without adjustment. If, however, there is a positional and/or speed difference between the actuators 112 and 114, the control unit 130 adjusts the motion of the actuators 112 and 114. For example, if the control unit 130 determines that the actuator 112 is at an advanced position in relation to the actuator 114, the control unit 130 may reduce the speed of the actuator 112 until the actuator 114 catches up to the position of the actuator 112, at which point the control unit 130 operates the actuators 112 and 114 at the same speed or rate. Similarly, if the control unit 130 determines that the actuator 112 is moving at a faster rate or speed than the actuator 114, the control unit 130 may reduce the speed of the actuator 112 until the actuator 114 catches up to the position and speed of the actuator 112, at which point the control unit 130 operates the actuators 112 and 114 at the same speed.

Accordingly, the control unit 130 monitors the motion of the actuators 112 and 114 to determine if one of the actuators 112 and 114 is lagging behind the other of the actuators 112 and 114. The control unit 130 then adjusts the speed of the leading actuator 112 or 114 so that the lagging actuator 112 or 114 catches up, thereby synchronizing the actuators 112 and 114 and reducing a likelihood of the flap 102 skewing or twisting (or otherwise controlling a magnitude of skewing or twisting within acceptable limits).

Similarly, the control unit 130 compares the signals received from the sensors 124 and 126. The control unit 130 determines whether there is a positional and/or speed difference between the actuators 116 and 118 based on the signals received from the sensors 124 and 126. If there is no difference, the control unit 130 continues to operate the actuators 116 and 118 without adjustment. If, however, there is a positional and/or speed difference between the actuators 116 and 118, the control unit 130 adjusts the motion of the actuators 116 and 118. For example, if the control unit 130 determines that the actuator 116 is at an advanced position in relation to the actuator 118, the control unit 130 may reduce the speed of the actuator 116 until the actuator 118 catches up to the position of the actuator 118, at which point the control unit 130 operates the actuators 116 and 118 at the same speed. Similarly, if the control unit 130 determines that the actuator 116 is moving at a faster rate or speed than the actuator 118, the control unit 130 may reduce the speed of the actuator 116 until the actuator 118 catches up to the position and speed of the actuator 116, at which point the control unit 130 operates the actuators 116 and 118 at the same speed.

As such, the control unit 130 monitors the motion of the actuators 116 and 118 to determine if one of the actuators 116 and 118 is lagging behind the other of the actuators 116 and 118. The control unit 130 then adjusts the speed of the leading actuator 116 or 118 so that the lagging actuator 116 or 118 catches up, thereby synchronizing the actuators 116 and 118 and reducing a likelihood of the flap 108 skewing or twisting (or otherwise controlling a magnitude of skewing or twisting within acceptable limits).

Additionally, the control unit 130 monitors motion of the flaps 102 and 108 in relation to one another in order to ensure synchronized motion therebetween. As described above, the control unit 130 synchronizes motion of the actuators 112 and 114 coupled to the flap 102, as well as the motion of the actuators 116 and 118 coupled to the flap 108 in order to reduce the likelihood of the flaps skewing or twisting (or otherwise controlling a magnitude of skewing or twisting within acceptable limits). Through the signals received from the sensors 120, 122, 124, and 126, the control unit 130 determines the position and speed of each flap 102 and 108. The control unit 130 determines whether there is a difference between the position and/or speed of the flaps 102 and 108. If there is no difference between the position and/or speed of the flaps 102 and 108, the control unit 130 refrains from adjusting the motion of the flaps 102 and 108. If, however, the control unit 130 determines that one of the flaps 102 and 108 is lagging behind the other of the flaps 102 or 108 (with respect to position and/or speed), the control unit 130 adjusts the speed of the leading flap 102 or 108 until the lagging flap 102 or 108 catches up to the leading flap 102 or 108. When the lagging flap 102 or 108 catches up to the leading flap 102 or 108, the control unit 130 operates the flaps 102 and 108 (through the respective actuators 112, 114, 116, and 118) at the same rate.

As described above, the control unit 130 is in communication with actuators 112, 114, 116, 118, and the sensors 120, 122, 124, and 126. The control unit receives sensor signals from the sensors 120 and 112, for example. The sensor signals relate to one or both of a position or speed of a respective actuator 112 and 114. The control unit 130 compares the received second sensor signals to determine a difference therebetween. The control unit 130 adjusts the speed of one or both of the actuators 112 and 114 based on the difference between the first and second sensor signals. For example, the control unit 130 may slow the speed of a leading actuator until a lagging actuator catches up to the leading actuator. In at least one other embodiment, the control unit 130 may optionally increase the speed of a lagging actuator until the lagging actuator catches up to the leading actuator. In at least one other embodiment, the control unit 130 may increase the speed of a lagging actuator and decrease the speed of a leading actuator until the lagging actuator catches up to the leading actuator. The control unit 130 may operate the actuators 116 and 118 in a similar fashion.

Further, the control unit 130 may compare the position and speed of the flaps 102 and 108. The control unit 130 may decrease the speed of a leading flap until the lagging flap catches up to a leading flap. In at least one other embodiment, the control unit 130 may increase the speed of a lagging flap until the lagging flap catches up to the leading flap. In at least one other embodiment, the control unit 130 may increase the speed of a lagging flap and decrease the speed of a leading flap until the lagging flap catches up to the leading flap.

As used herein, the term “control unit,” “unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 130 may be or include one or more processors that are configured to control operation of the flaps 102 and 108, as described above.

The control unit 130 is configured to execute a set of instructions that are stored in one or more storage elements (such as one or more memories), in order to process data. For example, the control unit 130 may include or be coupled to one or more memories. The storage elements may also store data or other information as desired or needed. The storage elements may be in the form of an information source or a physical memory element within a processing machine.

The set of instructions may include various commands that instruct the control unit 130 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the control unit 130. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 130 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

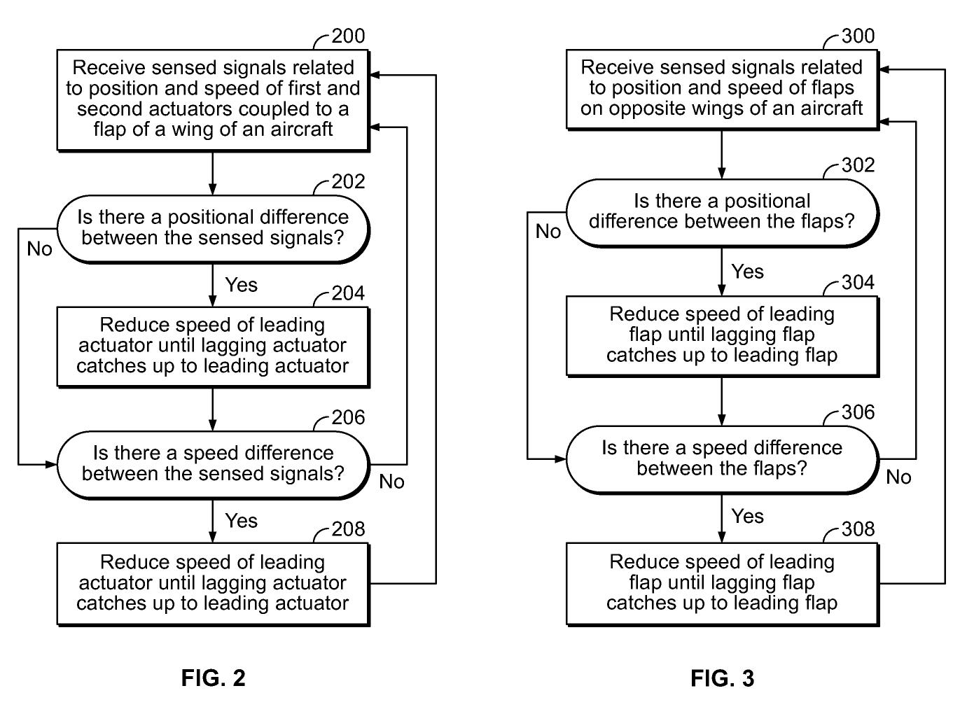

FIG. 2 illustrates a flow chart of a method of synchronizing actuators coupled to a flap of wing of an aircraft, according to an embodiment of the present disclosure. The control unit 130 (shown in FIG. 1) may operate according to the flow chart shown and described with respect to FIG. 2.

Initially, a command is input from a pilot flap handle, or other such input device. Then, at 200, sensed signals (such as output by one or more sensors coupled to actuators and/or a flap) related to position and speed of first and second actuators coupled to a flap of a wing are received, such as by the control unit 130. At 202, it is determined (such as by the control unit 130) if there is a positional difference between the sensed signals. If there is a positional difference, the speed of a leading actuator is reduced until a lagging actuator catches up to the leading actuator at 204. Optionally, the speed of the lagging actuator may be increased until the lagging actuator catches up to the leading actuator. In at least one other embodiment, the speed of the leading actuator may be reduced, and the speed of the lagging actuator may be increased until the lagging actuator catches up to the leading actuator. The method then proceed from 204 to 206, in which it is determined if there is a speed difference between the sensed signals. If there is a speed difference between the sensed signals, the method proceeds from 206 to 208, in which the speed of the leading actuator is reduced until the lagging actuator catches up to the leading actuator. Optionally, the speed of the lagging actuator may be increased until the lagging actuator catches up to the leading actuator. In at least one other embodiment, the speed of the leading actuator may be reduced, and the speed of the lagging actuator may be increased until the lagging actuator catches up to the leading actuator. The method then returns to 200.

If, at 202, there is not a positional difference between the sensed signals, the method proceeds from 202 to 206. If, at 206, there is not a speed difference between the sensed signals, the method returns to 200.

FIG. 3 illustrates a flow chart of a method of synchronizing flaps moveably secured to wings of an aircraft, according to an embodiment of the present disclosure. The control unit 130 (shown in FIG. 1) may operate according to the flow chart shown and described with respect to FIG. 3.

Initially, a command is input from a pilot flap handle, or other such input device. Then, at 300, sensed signals related to position and speed of flaps on opposite wings of an aircraft are received, such as by the control unit 130. The control unit 130 may compare the flaps to one another, after the control unit 130 has synchronized the actuators coupled to each flap to reduce the likelihood of flap skew or twist (or otherwise controlling a magnitude of skewing or twisting within acceptable limits). For example, the method shown and described in FIG. 3 may occur subsequent to, or simultaneously with, the method shown and described in FIG. 2. The sensed signals may be output by the sensors coupled to the actuators and/or flaps.

At 302, it is determined (such as by the control unit 130) if there is a positional difference between the flaps. The positions of the flaps may be compared relative to one another (through an analysis of the sensed signals) to determine if there is a difference between angular, linear, and/or rotational positions of the flaps. If there is a positional difference between the flaps, the method proceeds from 302 to 304, in which the speed of a leading flap is reduced until a lagging flap catches up to the leading flap. Optionally, the speed of the lagging flap may be increased until the lagging flap catches up to the leading flap. In at least one other embodiment, the speed of the leading flap may be reduced, and the speed of the lagging flap may be increased until the lagging flap catches up to the leading flap. The method then proceeds from 304 to 306, in which it is determined if there is a speed difference between the flaps. If there is a speed difference between the flaps, the method proceeds from 306 to 308, in which the speed of the leading flap is reduced until the lagging flap catches up to the leading flap. Optionally, the speed of the lagging flap may be increased until the lagging flap catches up to the leading flap. In at least one other embodiment, the speed of the leading flap may be reduced, and the speed of the lagging flap may be increased until the lagging flap catches up to the leading flap. The method then returns to 300.

If, at 302, there is not a positional difference between the flaps, the method proceeds from 302 to 306. If, at 306, there is not a speed difference between the flaps, the method returns to 300.

Referring to FIGS. 1-3, the control unit 130 may compare and adjust positions and speeds of actuators and/or flaps. The comparison and adjustment may occur after high lift systems have been monitored for errors, such as described in U.S. Pat. No. 9,193,479, entitled “Monitoring of High-Lift Systems for Aircraft.” The control unit 130 and/or another controller or control unit may monitor the high lift systems for errors.

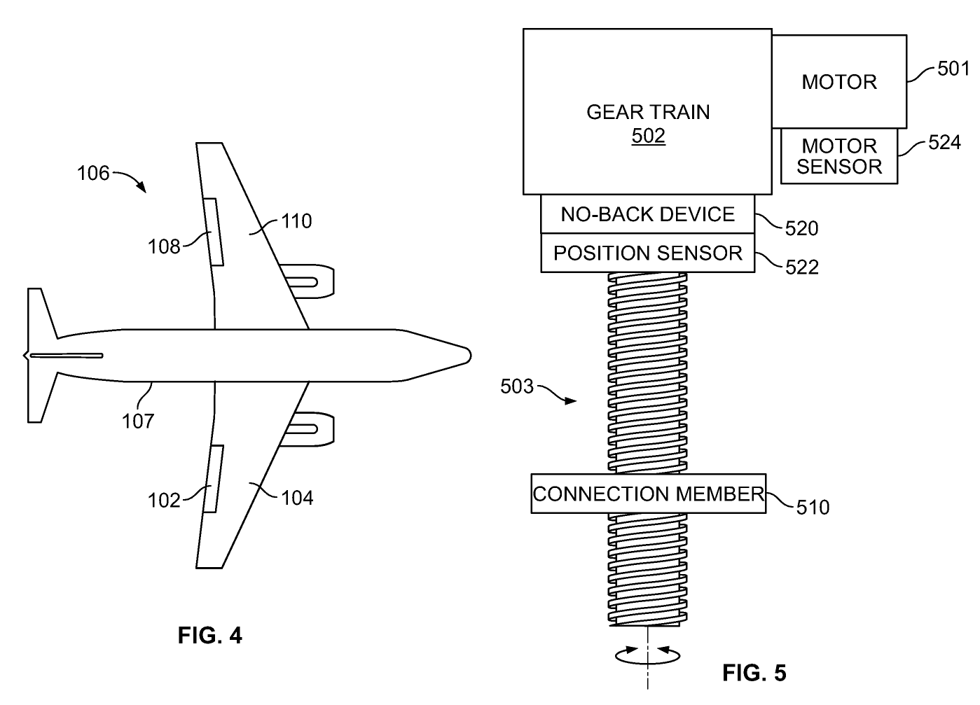

FIG. 4 is a diagrammatic representation of a top plan view of the aircraft 106, according to an embodiment of the present disclosure. The aircraft 106 includes a fuselage 107 and the wings 104 and 110 extending from respective right and left sides of the fuselage 107. The wings 104 and 110 include the extendable flaps 102 and 108 that are configured to increase drag or lift when extended from a trailing edge of the wings 104 and 110. The flaps 102 and 108 are part of a high-lift system implemented in the aircraft 106. Although one flap is illustrated on each wing 104 and 110, it is to be understood that multiple flaps may be installed on each of the wings 104 and 110.

Referring to FIGS. 1 and 4, the control unit 130 extends or retracts the flaps 102 and 108 in response to inputs from a pilot, a flight control system, and/or the like. The control unit 130 may provide electrical power to each of the actuators 112, 114, 116, and 118 (electrical power may also or alternatively be supplied by the aircraft electrical power system). The actuators 112, 114, 116, and 118 may be electrically controlled, and may therefore be referred to as Electrical-Mechanical Actuators (EMAs). The control unit 130 monitors operation of the actuators 112, 114, 116, and 118 through the sensors 120, 122, 124, and 126, which may be integrated with the actuators 112, 114, 116, and 118, respectively.

FIG. 5 is a diagrammatic representation of an actuator 500, according to an embodiment of the present disclosure. One or more of the actuators 112, 114, 116, and 118 (shown in FIG. 1) may be configured as the actuator 500, which may be a drive station.

The actuator 500 may include an electric motor 501, a gear train 502, and a drive screw 503. The motor 501 is able to turn clockwise or counterclockwise in response to the signals from the control unit 130 (shown in FIG. 1). The rotational motion of the motor 501 turns a series of gears within the gear train 502, which may be used to slow down the rotational motion of the motor 501. The gear train 502 in turn imparts rotational motion on the drive screw 503. The drive screw 503 includes a connection member 510, such as a ball nut and gimbal, that moves upward or downward along the drive screw 503 as the drive screw 503 turns. Therefore, the drive screw 503 converts the rotational motion of the motor 501 and the gear train 502 into a linear motion of the connection member 510. Although not shown in FIG. 5, the connection member 510 is configured to attach to one end of an arm (not shown), while the other end of the arm connects to a side of a flap. Thus, when the connection member 510 moves up and down on the drive screw 503, the motion imparts movement on the arm to extend or retract the flap.

The actuator 500 may also include a no-back device 520. The no-back device 520 acts as a brake to ensure irreversibility of the flap if the actuator 500 becomes disconnected from the flap. For example, if the motor 501 is inoperable, then the no-back device 520 engages to stop the flap from moving.

The actuator 500 may also include an integrated position sensor 522. The position sensor 522 may be positioned between the no-back device 520 and the flap, and monitors an output position of the actuator 500 (for example, the rotation angle of the drive screw 503). The position sensor 522 may alternatively be installed at the connection member 510, and/or directly attached to the flap.

The actuator 500 may also include a motor sensor 524. The motor sensor 524 may be configured to monitor a current draw or load on the motor 501. The motor sensor 524 may also monitor a position and/or speed of the motor 501. The position of the motor 501 may be indicated by a number of turns in either a forward or a reverse direction with a hall effect or a rotary type sensor, for example.

Referring to FIGS. 1-5, embodiments of the present disclosure provide systems and methods that synchronize flap motion of one or more wings of an aircraft. Embodiments of the present disclosure provide systems and methods that prevent, minimize, or other reduce the potential of a flap to skew or twist during operation. Embodiments of the present disclosure provide systems and methods that prevent, minimize, or otherwise reduce asymmetry between wings of an aircraft flap system. Embodiments of the present disclosure may be used to control leading edge flaps and/or trailing edge flaps.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system for controlling one or more flaps of an aircraft, the system comprising:
a first flap moveably secured to a first wing of the aircraft, the first flap being moveable between an extended position and a retracted position;
a first actuator coupled to the first flap;
a first sensor coupled to the first actuator, wherein the first sensor is configured to determine one or both of a position or speed of the first actuator and output a first sensor signal that relates to one or both of the position or the speed of the first actuator;
a second actuator coupled to the first flap;
a second sensor coupled to the second actuator, wherein the second sensor is configured to determine one or both of a position or speed of the second actuator and output a second sensor signal that relates to one or both of the position or the speed of the second actuator; and
a control unit in communication with the first actuator, the first sensor, the second actuator, and the second sensor, wherein the control unit is configured to:
receive the first and second sensor signals from the first and second sensors, respectively;
compare the first and second sensor signals to determine a difference between the first and second sensor signals; and
adjust the speed of one or both of the first or second actuators based on the difference between the first and second sensor signals.

2. The system of claim 1, wherein the control unit is configured to adjust the speed of one or both of the first and second actuators by decreasing the speed of a leading one of the first and second actuators that leads a lagging one of the first and second actuators until the lagging one of the first and second actuators catches up to the leading one of the first and second actuators.

3. The system of claim 1, wherein the control unit is configured to adjust the speed of one or both of the first and second actuators by increasing the speed of a lagging one of the first and second actuators that lags behind a leading one of the first and second actuators until the lagging one of the first and second actuators catches up to the leading one of the first and second actuators.

4. The system of claim 1, wherein the control unit is configured to adjust the speed of one or both of the first and second actuators by decreasing the speed of a leading one of the first and second actuators that leads a lagging one of the first and second actuators and increasing the speed of the lagging one of the first and second actuators until the lagging one of the first and second actuators catches up to the leading one of the first and second actuators.

5. The system of claim 1, further comprising:
a second flap moveably secured to a second wing of the aircraft, the second flap being moveable between an extended position and a retracted position;
a third actuator coupled to the second flap;
a third sensor coupled to the third actuator, wherein the third sensor is configured to determine one or both of a position or speed of the third actuator and output a third sensor signal related to one or both of the position or the speed of the third actuator;
a fourth actuator coupled to the second flap;
a fourth sensor coupled to the fourth actuator, wherein the fourth sensor is configured to determine one or both of a position or speed of the fourth actuator and output a fourth sensor signal related to one or both of the position or the speed of the fourth actuator,
wherein the control unit is in communication with the third actuator, the third sensor, the fourth actuator, and the fourth sensor, wherein the control unit is further configured to:
receive the third and fourth sensor signals from the third and fourth sensors, respectively;
compare the third and fourth sensor signals to determine a difference between the third and fourth sensor signals; and
adjust the speed of one or both of the third or fourth actuators based on the difference between the third and fourth sensor signals.

6. The system of claim 5, wherein the control unit is configured to:
determine a difference between one or both of speed or position of the first and second flaps; and
adjust the speed of one or both of the first and second flaps based on the difference between one or both of the speed or the position of the first and second flaps.

7. The system of claim 6, wherein the control unit is configured determine the difference between one or both of the speed or position of the first and second flaps by analyzing the first, second, third, and fourth sensor signals.

8. The system of claim 6, wherein the control unit is configured to adjust the speed of one or both of the first and second flaps by decreasing the speed of a leading one of the first and second flaps that leads a lagging one of the first and second flaps until the lagging one of the first and second flaps catches up to the leading one of the first and second flaps.

9. The system of claim 6, wherein the control unit is configured to adjust the speed of one or both of the first and second flaps by increasing the speed of a lagging one of the first and second flaps that lags behind a leading one of the first and second flaps until the lagging one of the first and second flaps catches up to the leading one of the first and second flaps.

10. The system of claim 6, wherein the control unit is configured to adjust the speed of one or both of the first and second flaps by decreasing the speed of a leading one of the first and second flaps that leads a lagging one of the first and second flaps and increasing the speed of the lagging one of the first and second flaps until the lagging one of the first and second flaps catches up to the leading one of the first and second flaps.

11. A method of controlling one or more flaps of an aircraft, the method comprising:
receiving first and second sensor signals from respective first and second sensors coupled to respective first and second actuators that are moveably secured to a first flap of a first wing of the aircraft, wherein the first and second sensor signals relate to one or both of the position or the speed of the respective first and second actuators;
comparing the first and second sensor signals to determine a difference between the first and second sensor signals; and
adjusting the speed of one or both of the first or second actuators based on the difference between the first and second sensor signals.

12. The method of claim 11, wherein the adjusting operation comprises decreasing the speed of a leading one of the first and second actuators that leads a lagging one of the first and second actuators until the lagging one of the first and second actuators catches up to the leading one of the first and second actuators.

13. The method of claim 11, wherein the adjusting operation comprises increasing the speed of a lagging one of the first and second actuators that lags behind a leading one of the first and second actuators until the lagging one of the first and second actuators catches up to the leading one of the first and second actuators.

14. The method of claim 11, wherein the adjusting operation comprises:
decreasing the speed of a leading one of the first and second actuators that leads a lagging one of the first and second actuators; and
increasing the speed of the lagging one of the first and second actuators until the lagging one of the first and second actuators catches up to the leading one of the first and second actuators.

15. The method of claim 11, further comprising:
receiving third and fourth sensor signals from respective third and fourth sensors coupled to respective third and fourth actuators that are moveably secured to a second flap of a second wing of the aircraft, wherein the third and fourth sensor signals relate to one or both of the position or the speed of the respective third and fourth actuators;
comparing the third and fourth sensor signals to determine a difference between the third and fourth sensor signals; and
adjusting the speed of one or both of the third or fourth actuators based on the difference between the third and fourth sensor signals.

16. The method of claim 15, further comprising:
determining a difference between one or both of speed or position of the first and second flaps; and
adjusting the speed of one or both of the first and second flaps based on the difference between one or both of the speed or the position of the first and second flaps.

17. The method of claim 15, wherein the determining the difference between one or both of speed or position of the first and second flaps operation comprises analyzing the first, second, third, and fourth sensor signals.

18. The method of claim 15, wherein the adjusting the speed of one or both of the first and second flaps operation comprises decreasing the speed of a leading one of the first and second flaps that leads a lagging one of the first and second flaps until the lagging one of the first and second flaps catches up to the leading one of the first and second flaps.

19. The method of claim 15, wherein the adjusting the speed of one or both of the first and second flaps operation comprises increasing the speed of a lagging one of the first and second flaps that lags behind a leading one of the first and second flaps until the lagging one of the first and second flaps catches up to the leading one of the first and second flaps.

20. The method of claim 15, wherein the adjusting the speed of one or both of the first and second flaps operation comprises:
decreasing the speed of a leading one of the first and second flaps that leads a lagging one of the first and second flaps; and
increasing the speed of the lagging one of the first and second flaps until the lagging one of the first and second flaps catches up to the leading one of the first and second flaps.
